(19) United States
(12) Patent Application Publication
(10) Pub. No.: US 2021/0248108 A1
(43) Pub. Date: Aug. 12, 2021

(54) ASYNCHRONOUS DATA SYNCHRONIZATION AND RECONCILIATION

(71) Applicant: Hitachi, Ltd., Tokyo (JP)

(72) Inventor: Pablo MARTINEZ LERIN, Waltham, MA (US)

(21) Appl. No.: 16/783,199

(22) Filed: Feb. 6, 2020

(51) Int. Cl. G06F 16/178; G06F 16/174; G06F 16/17; G06F 16/182; G06F 16/23

(52) U.S. Cl. CPC G06F 16/178; G06F 16/1748; G06F 16/2322; G06F 16/1824; G06F 16/1734

(57) ABSTRACT

In some examples, a first computing device may generate a first data structure that includes a listing of one or more objects having been determined to be more likely than other objects stored by the first computing device to have been incorrectly synchronized to a second computing device. Based at least in part on a first object being listed in the first data structure, the first computing device may compare a state of the first object with a state of a synchronized object stored by the second computing device. Further, based at least on determining a difference between the state of the first object and the state of the synchronized object, the first computing device may reconcile the difference by causing at least one data operation to be performed at the second computing device to change the state of the synchronized object.

### BACKGROUND

Data objects may be stored in an object storage architecture that manages data as objects. An object storage architecture may include multiple computing devices and associated storage that may be used to store data objects for users. For example, the data objects may be stored as data that may include data content and associated metadata. To provide protection against data loss and/or to provide better access to the data, the data may be synchronized or otherwise synchronized across multiple storage system and/or multiple storage sites. This enables one or more redundant copies of the data to be available, irrespective of failure conditions, such as disk failure, node failure, communication network congestion or failure, or even complete failure of a site.

Data that has been synchronized asynchronously may typically undergo reconciliation to ensure that the synchronized data is consistent with the source data. However, conventional reconciliation techniques do not scale well because a storage system may have many millions or many billions of objects, so techniques such as checking all the objects one by one may require a large amount of computational resources and time. Moreover, conventional reconciliation techniques may require collaboration between the local storage system and the external storage system, which might not be available in certain system configurations, such as when different storages included in the system are provided by different vendor entities or the like.

### SUMMARY

In some implementations, a first computing device may generate a first data structure that includes a listing of one or more objects having been determined to be more likely than other objects stored by the first computing device to have been incorrectly synchronized to a second computing device. Based at least in part on a first object being listed in the first data structure, the first computing device may compare a state of the first object with a state of a synchronized object stored by the second computing device. Further, based at least on determining a difference between the state of the first object and the state of the synchronized object, the first computing device may reconcile the difference by causing at least one data operation to be performed at the second computing device to change the state of the synchronized object.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture of a system able to perform data storage, synchronization and reconciliation according to some implementations.

FIG. 2 illustrates an example hardware and logical configuration of a service computing device according to some implementations.

FIG. 3 illustrates an example hardware and logical configuration of a target computing device according to some implementations.

FIG. 4 illustrates an example of the recent activity data structure according to some implementations.

FIG. 5 illustrates an example of the suspect objects data structure according to some implementations.

FIG. 6 is a flow diagram illustrating an example process for handling incoming data operation requests according to some implementations.

FIG. 7 is a flow diagram illustrating an example process for recovering from a failure of a synchronization worker process according to some implementations.

FIG. 8 is a flow diagram illustrating an example process for reconciling suspect objects according to some implementations.

### DESCRIPTION

Some implementations herein are directed to techniques and arrangements for asynchronous data synchronization for asymmetric storage systems with fast reconciliation of synchronized data. The examples herein may be applied to an object data storage system (i.e., a local storage system) to synchronize data to one or more remote or otherwise external storage systems (i.e., synchronization target system(s)) without having direct software integration with the target external storage systems. As one example, the target external storage systems may be provided by entities that are separate from each other and separate from an entity managing the source storage system.

The local storage system herein may synchronize data to the one or more target storage systems and may be configured to identify any data that was not synchronized correctly (e.g., not synchronized in the correct order of operations, or the like). When the storage system identifies data that was not synchronized correctly, the storage system may perform one or more operations to correct or otherwise reconcile the data that was not synchronized correctly.

In some cases, the storage system may keep track of the objects that are suspected of having been affected by improper synchronization operations such as due to synchronization process failure, due to multiple asynchronous synchronization operations being performed in parallel, or the like, and may identify these objects as suspect objects. In addition, the storage system may check, before deleting the data of an object, whether the object is suspected of not having been synchronized correctly, to avoid losing data that may be needed to correct or otherwise reconcile the synchronized data.

The data synchronized herein may include object data content, such as may be received from a client computer in a data write request or the like. Examples of object data content may include the content of documents, images, music, movies, or content of any of numerous other types of data files or other types of data objects. The data synchronized herein may further include metadata corresponding to the synchronized data content, which may include information about the content of the object and/or system information about the data object. When a client sends a request to write data to the storage system, the storage system may store the content data and the metadata corresponding to the write request locally, may respond to the client device to indicate that the write request has been completed, and may subsequently asynchronously synchronize the data to one or more external systems to create one or more redundant copies of the data.

In some examples herein, to achieve high throughput, the data may be synchronized using multiple synchronization worker processes which may be able to execute in parallel. Further, there may be several reasons why the data in the source (local) storage system and the data in the target (external) storage system(s) may become inconsistent such that the data is not synchronized correctly. As one example, a synchronization worker process that is synchronizing particular data may fail while synchronizing the particular data. Since operations across source and target storage systems typically are not performed atomically, in the case of synchronization process failure, the source system may identify the associated object as being suspect and may check whether the object was properly synchronized to the target system. If the data was not synchronized correctly to the target system, then the source system may cause one or more data operations to be performed at the target system to reconcile the synchronized data to conform the state of the synchronized data to the state of the data in the source storage system.

As another example, several data operations that are directed to the same object might occur at the source storage system within a very short time interval, which can also result in inconsistent synchronization of the data. For instance, suppose that an object write operation and an object delete operation are received for the same object within a short period of time. If those operations are synchronized and processed in the wrong order by the synchronization worker processes in charge of synchronizing the data, the resulting data synchronized in the target system may not be synchronized correctly. The source system herein may be configured to check and, if necessary, reconcile the data in this scenario as well. For instance, if the synchronization workers first synchronize a write and then a delete, the result may be that the data is deleted in the target storage system, but if the data is synchronized in the opposite order, the result may be that the data still exists in the target storage system. Accordingly, the solution provided herein addresses and corrects the above-mentioned scenarios and/or other scenarios in which data is improperly synchronized to one or more target storage systems.

For discussion purposes, some example implementations are described in the environment of a source (local) storage system that synchronizes data to one or more target (external) storage systems. The system may subsequently identify and reconcile any incorrectly synchronized data. However, implementations herein are not limited to the particular examples provided, and may be extended to other types of computing system architectures, other types of storage environments, other types of client configurations, other types of data, and so forth, as will be apparent to those of skill in the art in light of the disclosure herein. Accordingly, implementations herein are not limited to use with the particular examples provided.

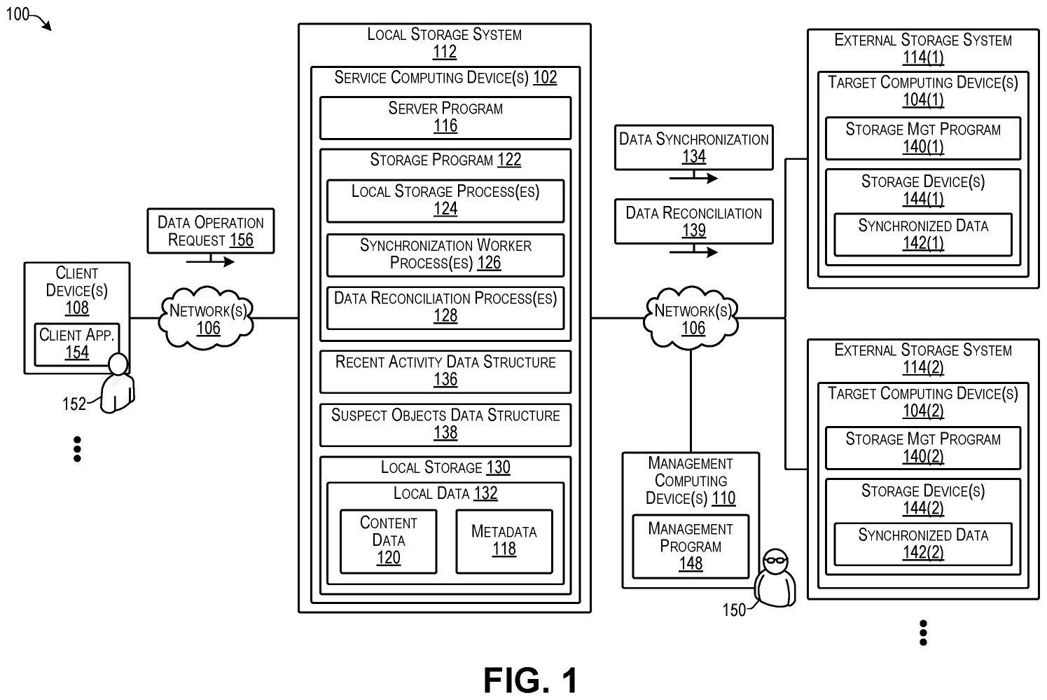

FIG. 1 illustrates an example architecture of a system 100 able to perform data storage, synchronization and reconciliation according to some implementations. The system 100 includes one or more service computing devices 102 that are able to communicate with, or otherwise coupled to, one or more target computing devices 104, such as, in this example, target computing devices 104(1), 104(2), . . . , through one or more networks 106. Further, the service computing device(s) 102 are able to communicate over the network(s) 106 with one or more client computing devices 108, which may be any of various types of computing devices, as discussed additionally below. In addition, one or more management computing devices 110 are able to communicate with the service computing device(s) 102 and the target computing device(s) 104, such as through the network(s) 106.

Service computing devices 102 may be included in a local storage system 112, and the target computing devices 104 may be included in respective external storage systems 114, such as external storage system 114(1) and external storage system 114(2), respectively, in the illustrated example. In some examples, the local storage system 112 may be operated by a first entity and the external storage systems 114 may be operated by different entities, e.g., different storage vendors, that are unrelated to the first entity that operates the local storage system 112. For instance, in some cases, the external storage systems 114 may be network storage systems that may be commercial or proprietary storage systems. Examples of commercial network storage providers include AMAZON WEB SERVICES, MICROSOFT AZURE, GOOGLE CLOUD, IBM CLOUD, and ORACLE CLOUD, to name a few, who may provide storage services that may serve as an external storage system 114. In some examples, the external storage systems 114 may be referred to as “cloud storage” or “cloud-based storage”, and may enable a lower cost storage solution per gigabyte than local storage that may be available at the local storage system 112 in some cases. Additionally, in some examples, one or more of the storage-providing entities of the external storage systems 114 may alternatively be private or otherwise proprietary storage providers such as for providing access only to specific users, specific entities, or the like, e.g., associated with the local storage system 112. An example of a proprietary external storage system may include a configuration of HITACHI CONTENT PLATFORM storage.

The one or more networks 106 may include any suitable network, including a wide area network, such as the Internet; a local area network (LAN), such as an intranet; a wireless network, such as a cellular network, a local wireless network, such as Wi-Fi, and/or short-range wireless communications, such as BLUETOOTH®; a wired network including Fibre Channel, fiber optics, Ethernet, INFINIBAND, or any other such network, a direct wired connection, or any combination thereof. Accordingly, the one or more networks 106 may include both wired and/or wireless communication technologies. Components used for such communications can depend at least in part upon the type of network, the environment selected, or both. Protocols for communicating over such networks are well known and will not be discussed herein in detail.

In some cases, the network(s) 106 may be implemented as two or more separate networks. As one example, the network(s) 106 may include a frontend network for transmitting communications, such as read and write requests, between client devices 108 and the service computing device(s) 102. Further, in some examples, the network(s) 106 may include a backend network for transmitting communications between the service computing device(s) 102 and the target computing devices 104, and a management network for enabling communication between the management computing device(s) 110, the service computing device(s) 102 and, in some cases, the target computing devices 104. Regardless of the network type, the service computing device(s) 102, the target computing devices 104, the client devices 108, and the management computing device(s) 110 may be able to communicate over the one or more networks 106 using wired and wireless connections, or combinations thereof.

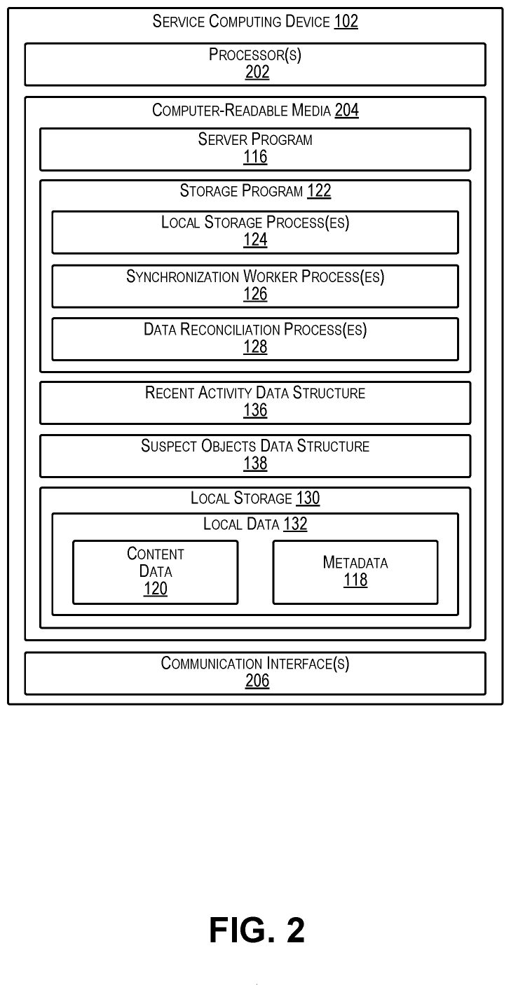

The service computing device(s) 102 may include one or more servers or any other suitable computing devices, as discussed additionally below, e.g., with respect to FIG. 2. One or more of the service computing device(s) 102 may include a server program 116 that may be executed to enable the service computing device(s) 102 to respond to requests from the client devices 108, such as for storing user data, providing access to stored data, executing user requests, and so forth. Further, the server program 116 may manage storage of metadata 118 that is related to the stored object content data 120. The metadata 118 may also include system metadata that is generated by the server program 116, such as for determining an internal name, storage location, storage path, or the like, for each stored data object or other stored data. Thus, the metadata 118 may include information about the stored data and may further include information regarding where and how the data is stored by the service computing device(s) 102 and the target computing device(s) 104, such as to enable storing and accessing the data. In some examples, the metadata 118 may be stored by the service computing device(s) 102 in a database or other type of data structure managed by the server program 116.

In addition, one or more of the service computing device(s) 102 may include a storage program 122 that may be executed on at least one of the service computing device(s) 102 to perform storage operations. For example, the storage program 122 may be executed to perform one or more local storage processes 124, one or more synchronization worker processes 126, and/or one or more data reconciliation processes 128. The local storage process(es) 124 may be executed to store and manage the received data locally on a local storage 130 as local data 132, which may include the metadata 118 and the content data 120. Examples of local storage processes 124 may include storing and retrieving local data 132 in the local storage 130, managing synchronization, managing data lifecycles, archiving, storage protection levels, storage class hierarchies, disaster recovery, garbage collection, and so forth. In addition, the synchronization worker process(es) 126 may be executed to perform data synchronization 134 to synchronize at least some of the local data 132 to one or more of the target computing devices 104 at one or more of the external storage systems 114. For example, based on one or more configured synchronization rules or various other considerations, one or more copies of the local data 132, which may include content data 120 and/or metadata 118, together or separately, may be synchronized to one or more of the external storage systems 114.

The storage program 122 may maintain a recent activity data structure 136 the lists object that have been subject to data operations. The storage program 120 may use the recent activity data structure 136 to determine, at least in part, objects that are more likely than other objects stored by the local storage system 114 to have been incorrectly synchronized. These suspect objects may be listed as entries in a suspect objects data structure 138.

Furthermore, following synchronization, following the elapse of a period of time, or in response to one or more other triggering events, as enumerated elsewhere herein, the storage program 122 may execute the data reconciliation process 128, which may include utilization of the suspect objects data structure 138 to perform data reconciliation 139. For example, the data reconciliation process 128 may use the suspect object data structure 138 to identify suspect data that is suspected of not having been synchronized correctly, and may subsequently perform one or more operations to identify and correct or otherwise reconcile any incorrectly synchronized data so that the state of the synchronized data matches the state of the corresponding local data. Depending in part on the architecture of the local storage system 112, the storage program 122 may be installed and executed on a single service computing device 102 or may be installed and executed on multiples ones of the service computing devices 102 or all of the service computing devices 102 at the local storage system 112.

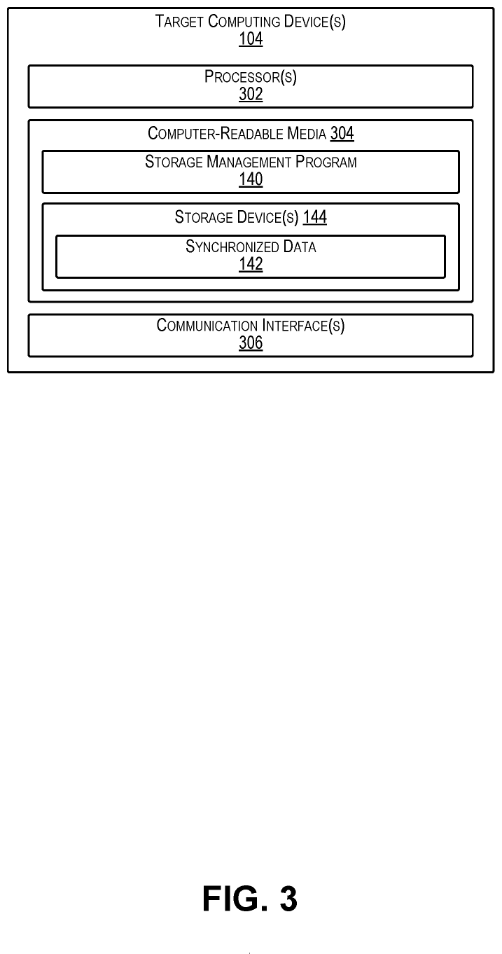

The target computing devices 104 at the external storage systems 114 may include one or more servers, storage systems, storage controllers, storage arrays, network storage, and/or any other suitable computing devices able to store data, as discussed additionally below, e.g., with respect to FIG. 3. For instance, individual target computing devices 104(1), 104(2) may execute storage management programs 140(1), 140(2), respectively, for managing the storage of synchronized data 142(1), 142(2), respectively, by the target computing devices 104(1), 104(2), respectively, on storage devices 144(1), 144(2), respectively. The target computing devices 104(1), 104(2) may be configured by the respective storage management program 140(1), 140(2) to store the synchronized data 142(1), 142(2) when received from the service computing device(s) 102, and to retrieve the respective synchronized data 142(1), 142(2) when requested by the service computing device(s) 102 or by client devices 108. In addition, the respective storage management program 140(1), 140(2) may configure the respective target computing devices 104(1), 140(2) to perform various other storage functions, such as for managing data lifecycles, archiving, storage protection levels, storage class hierarchies, disaster recovery, garbage collection, and so forth.

In the examples in which external storage systems 114(1) and 114(2) are provided by different entities, the respective storage management programs 140(1) and 140(2) may be entirely different programs, which may use the same communication and/or storage protocols, similar communication and/or storage protocols, or partially or entirely different communication and/or storage protocols. Nevertheless, implementations herein are able to accommodate any differences in storage and/or communication protocols for performing the data synchronization and reconciliation described herein.

The management computing device(s) 110 may execute a management program 148 that may be used by an administrator 150 for managing the system 100. For example, the administrator 150 may be responsible for adding more service computing device(s) 102 to the local storage system 112. In addition, the administrator 150 may be responsible for configuring and managing the service computing devices 102 for ensuring proper operation, as is known in the art. Additionally, in some cases, the administrator 150 may also configure and manage the target computing devices 104. Further, in some examples, the management computing device(s) may also be one or more of the service computing device(s) 102 and vice versa.

Each client device 108 may be any suitable type of computing device such as a desktop, laptop, tablet computing device, mobile device, smart phone, wearable device, and/or any other type of computing device able to send data over a network. A user 152 may be associated with each client device 108, such as through a respective user account, user login credentials, or the like. Furthermore, the client device(s) 108 may be able to communicate with the service computing device(s) 102 and/or the target computing devices 104 through the one or more networks 106 or through any other suitable type of communication connection.

Further, each client device 108 may include an instance of a user application 154 that may execute on the client device 108, such as for communicating with the server program 116, e.g., for sending user data for storage on the target computing devices 104 and/or for receiving stored data from the target computing devices 104. In some cases, the client application 154 may include a browser or may operate through a browser, and the server program 116 may include a web application for enabling the user 152 to access local data 132 through one of the service computing device(s) 102. Alternatively, in other cases, the client application 154 may include any other type of application having communication functionality enabling communication with the server program 116 over the one or more networks 106.

In the system 100, the users 152 may store data to and receive data from the service computing device(s) 102 (and/or the target computing device(s) 104 in some cases) that their respective client devices 108 are in communication with. Accordingly, one or more of the service computing devices 102 may provide storage for the user 152 and the respective client device 108. During steady state operation there may be multiple client devices 108 periodically communicating with respective ones of the service computing device(s) 102 for storing and retrieving data.

In the example of FIG. 1, suppose that the user 152 uses the client application 154 to send a data operation request 156 from the client device 108 to the service computing device(s) 102. For instance, the data operation request 156 may be a write request for storing or updating data, such as a data object, or the like. Alternatively, the data operation request 156 may be a delete request, may be an update to metadata associated with a data object, or the like, as discussed additionally elsewhere herein. The server program 116 may be executed on the service computing device(s) 102 to store any data included in the data operation request 156 to the local storage 130. The server program 116 on the service computing device(s)102 may further generate additional metadata for the received data and may send a response to the client device 108 indicating that the request has been completed. The storage program 122 executing on the service computing device(s) 102 may receive the data that was included in the data operation request 156 via the server program 116, and may store a content data portion of the data as part of the content data 120 and may store the metadata portion of the data as part of the metadata 118.

The synchronization worker process(es) 126 may subsequently be executed to perform the data synchronization 134 to synchronize the received local data 132 to one or more of the external storage systems 114. As one example, the synchronization may be performed according to one or more configured synchronization rules. For example, when data is written to the service computing device(s) 102, the synchronization rules may cause one or more copies of the data to be synchronized to one or more of the external storage systems 114. Similarly, if a data delete operation is received from a client device 108, or is generated based on other considerations, such a data lifecycle expiration event, the system synchronizes the delete operation, e.g., deletes the corresponding data in the external storage system(s), based on the configured synchronization rules.

In addition, the data reconciliation process(es) 128 may be executed to perform the data reconciliation 139 to detect and correct any incorrectly synchronized portions of the synchronized data 142. In some cases, the data reconciliation process 128 may be executed periodically. Additionally, or alternatively, as discussed additionally below, the service computing device 102 may check timestamps in the suspect objects data structure 138 and may initiate the data reconciliation process 128 for a particular entry when an age of the timestamp exceeds a time threshold for execution of the data reconciliation process 128. Alternatively, or in addition, the data reconciliation process 128 may be executed when the number of suspect objects in the suspect objects data structure 138 reaches a predefined or user-defined threshold. Alternatively, or in addition, the data reconciliation process 128 may be executed when a failure in a synchronization worker process 126 is detected. Alternatively, or in addition, the data reconciliation process 128 may be initiated by the administrator 150 and/or the management program 148, such as by an administrator instruction sent from the management computing device 110. Furthermore, while configurations will be apparent to those of skill in the art having the benefit of the disclosure herein.

FIG. 2 illustrates an example hardware and logical configuration of a service computing device 102 according to some implementations. In some examples, the service computing device 102 may include one or more servers that may be embodied in any number of ways. For instance, the programs, other functional components, and at least a portion of data storage of the service computing device 102 may be implemented on at least one server, such as in a cluster of servers, a server farm, a data center, a cloud-hosted computing service, and so forth, although other computer architectures may additionally or alternatively be used. In the illustrated example, the service computing device 102 includes, or may have associated therewith, one or more processors 202, one or more computer-readable media 204, and one or more communication interfaces 206.

Each processor 202 may be a single processing unit or a number of processing units, and may include single or multiple computing units, or multiple processing cores. The processor(s) 202 may be implemented as one or more central processing units, microprocessors, microcomputers, microcontrollers, digital signal processors, state machines, logic circuitries, and/or any devices that manipulate signals based on operational instructions. As one example, the processor(s) 202 may include one or more hardware processors and/or logic circuits of any suitable type specifically programmed or configured to execute the algorithms and processes described herein. The processor(s) 202 may be configured to fetch and execute computer-readable instructions stored in the computer-readable media 204, which may program the processor(s) 202 to perform the functions described herein.

The computer-readable media 204 may include both memory and storage, including the local storage 130. For example, the computer-readable media 204 may include volatile and nonvolatile memory and/or removable and non-removable media implemented in any type of technology for storage of information, such as computer-readable instructions, data structures, program modules, or other data. The computer-readable media 204 may include, but is not limited to, RAM, ROM, EEPROM, flash memory or other memory technology. Further, the computer-readable media 204 may include optical storage, solid-state storage, magnetic tape, magnetic disk storage, RAID storage systems, storage arrays, network-attached storage, storage area networks, cloud storage, or any other medium that can be used to store the desired information and that can be accessed by a computing device. Depending on the configuration of the service computing device 102, the computer-readable media 204 may include a tangible non-transitory media to the extent that, when mentioned, non-transitory computer-readable media exclude media such as energy, carrier signals, electromagnetic waves, and/or signals per se. In some cases, the computer-readable media 204 may be at the same location as the service computing device 102, while in other examples, a portion of the computer-readable media 204 may be partially remote from the service computing device 102.

The computer-readable media 204 may be used to store any number of functional components that are executable by the processor(s) 202. In many implementations, these functional components comprise instructions or programs that are executable by the processor(s) 202 and that, when executed, specifically program the processor(s) 202 to perform the actions attributed herein to the service computing device 102. Functional components stored in the computer-readable media 204 may include the server program 116 and the storage program 122, each of which may include one or more computer programs, applications, executable code, or portions thereof. For example, the server program 116 may provide communication functionality with the client devices 108 and the target computing devices 104, as well as managing the metadata 118.

The storage program 122 may be configured to perform the storage, synchronization and reconciliation operations described herein. For example, the storage program 122 may execute the local storage process(es) 124 to store received data in the local storage 130, may execute the synchronization worker process(es) 126 to synchronize data to the target computing devices 104, and may execute the data reconciliation process(es) 128 to reconcile the synchronized data if synchronization is determined to have been incorrectly performed, as described in additional detail elsewhere herein.

In addition, the computer-readable media 204 may store data, data structures, and other information used for performing the functions and services described herein. For example, the computer-readable media 204 may include the metadata 118 and the content data 120 stored in the local storage 130 portion of the computer-readable media 204. In addition, the computer-readable media 204 may store the recent activity data structure 136 and the suspect objects data structure 138. Details of each of the data structures 136 and 138 are discussed additionally below. As one example, in implementations in which there is more than one service computing device 102 (e.g., in a cluster or the like), the service computing devices 102 may each persistently store a portion of the recent activity data structure 136 and the suspect objects data structure 138, so that the tables are stored in a distributed manner across the plurality of service computing devices 102. For example, each service computing device 102 may maintain a respective recent activity data structure 136 and a respective suspect objects data structure 138 for the data managed by that service computing device, which may improve the speed for reading from and writing to the recent activity data structure 136 and the suspect objects data structure 138.

The service computing device 102 may also include or maintain other functional components and data, which may include programs, drivers, etc., and the data used or generated by the functional components. Further, the service computing device 102 may include many other logical, programmatic, and physical components, of which those described above are merely examples that are related to the discussion herein.

The one or more communication interfaces 206 may include one or more software and hardware components for enabling communication with various other devices, such as over the one or more network(s) 106. Thus, the communication interfaces 206 may include, or may couple to, one or more ports that provide connection to the network(s) 106 for communicating with the target computing devices 104, the other service computing device(s) 102, the client devices 108, and the management computing device(s) 110. For example, the communication interface(s) 206 may enable communication through one or more of a LAN, the Internet, cable networks, cellular networks, wireless networks (e.g., Wi-Fi) and wired networks (e.g., Fibre Channel, fiber optic, Ethernet, INFINIBAND), direct connections, as well as close-range communications such as BLUETOOTH®, and the like, as additionally enumerated elsewhere herein.

FIG. 3 illustrates an example hardware and logical configuration of a target computing device 104 according to some implementations. In some examples, the target computing device 104 may include one or more servers that may be embodied in any number of ways. For instance, the programs, other functional components, and at least a portion of data storage of the target computing device 104 may be implemented on at least one server, such as in a cluster of servers, a server farm, a data center, a cloud-hosted computing service, and so forth, although other computer architectures may additionally or alternatively be used. The target computing devices 104 may each include one or more processors 302, one or more computer-readable media 304, and one or more communication interfaces 306. For example, the processors 302 may correspond to any of the examples discussed above with respect to the processors 202, the computer-readable media 304 may correspond to any of the examples discussed above with respect to the computer-readable media 204, and the communication interfaces 306 may correspond to any of the examples discussed above with respect to the communication interfaces 206.

In the illustrated example, the computer-readable media 304 may include one or more of the storage devices 144 that may be used to store the synchronized data 142. In some examples, one or more dedicated storage controllers (not shown in FIG. 3) may be associated with the storage devices 144, such as in the case that the storage devices 144 are arranged in one or more arrays, or the like. For instance, as is known in the art, storage devices 144 may be configured in arrays, such as in a RAID configuration, JBOD configuration, or the like, and/or for presenting logical units based on the storage devices 144. The storage management program 140 may be executed by the one or more processors 302 for managing the data 126, such as data objects or other data, stored on the underlying physical storage devices 144. As mentioned above, the storage devices 144 may be any type of storage device, such as hard disk drives, solid state drives, optical drives, magnetic tape, combinations thereof, or any other type of non-transitory computer-readable medium able to store digital information. In some examples, the target computing devices 104 may include commercially available cloud storage as is known in the art, while in other examples, the target computing devices 104 may include private or enterprise storage systems accessible only by an entity associated with the service computing device(s) 102.

The computer-readable media 304 may be used to store any number of functional components that are executable by the processor(s) 302. In many implementations, these functional components comprise instructions or programs that are executable by the processor(s) 302 and that, when executed, specifically program the processor(s) 302 to perform the actions attributed herein to the service computing device 102. Functional components stored in the computer-readable media 304 may include the storage management program 140, which may include one or more computer programs, applications, executable code, or portions thereof. For example, the storage management program 140 may be configured to perform the data storage and management functions described herein to cause the target computing device 104 to store and retrieve received data, such as the synchronized data 142, manage retention periods, provide storage protection levels, and so forth, as discussed above.

In addition, the computer-readable media 304 may store the synchronized data 126, which may include user data, data object content, metadata, data structures, system data and other information used for performing the functions and services described herein. In addition, in some examples, the computer-readable media 304 may store non-synchronized data, e.g., data originally received directly from one or more of the client devices 108, or the like, and that is itself synchronized to one or more other storage systems 112, 114. Accordingly, in some cases, the logical configuration of the target computing device 104 may be similar to that of the service computing device 102. The target computing device 104 may also include or maintain other functional components and data, which may include programs, drivers, etc., and the data used or generated by the functional components. Further, the target computing device 104 may include many other logical, programmatic, and physical components, of which those described above are merely examples that are related to the discussion herein.

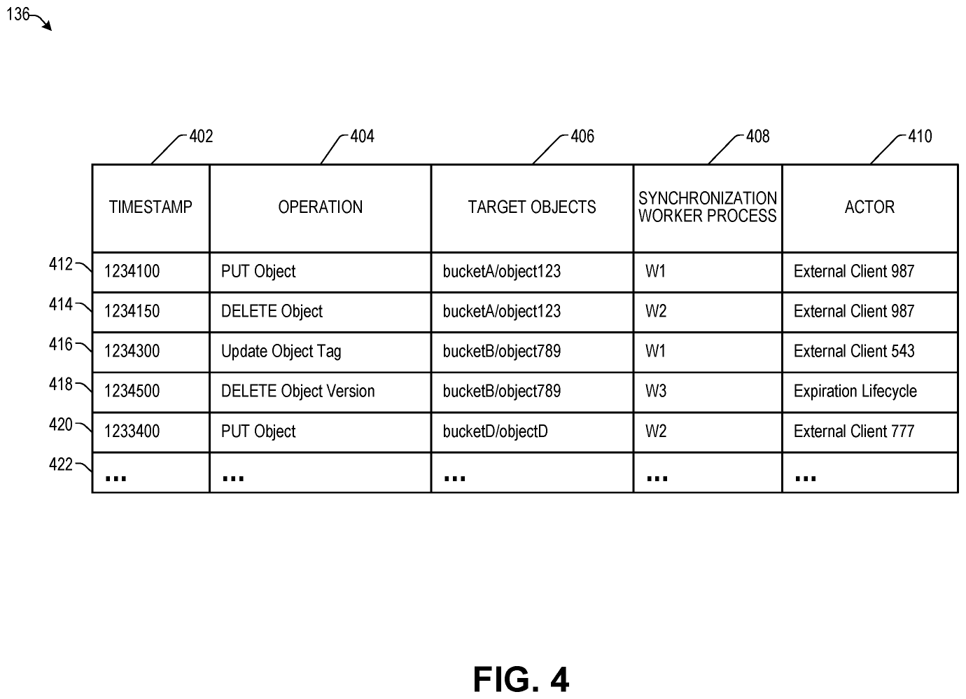

FIG. 4 illustrates an example of the recent activity data structure 136 according to some implementations. The recent activity data structure 136 in this example includes timestamp 402, operation 404, target objects 406, worker 408 and actor 410. Furthermore, each row 412-420 of the recent activity data structure 136 may include information corresponding to one data operation received by the service computing device 102, such as PUT or other type of data write operation, a delete operation, a metadata update operation, or the like.

As one example, the timestamp 402 may indicate a time value that represents the time at which the data operation was received by the service computing device 102. Alternatively, as another example, the timestamp 402 may be set to represent the time that metadata included in the data operation request was received from a client computing device 108.

The operation 404 may indicate the type of data operation performed by the service computing device 102. Several non-limiting examples of data operations may include “PUT object”, “DELETE object”, “Update object tag”, “DELETE Object version”, and so forth, with the actual operation names varying based on the protocols, application programming interfaces (APIs), libraries, programming languages, or the like, being used.

The target objects 406 indicate an object identifier of each target object that is the subject of the data operation performed in the service computing device 102. For example, some types of operations might typically be directed to only one target object. For instance, as indicated at row 412, the data operation “PUT object” may be targeted at the object123 that is to be written to bucketA. Additionally, some operations might have multiple target objects. For example, a BULK DELETE operation may be directed to multiple object for requesting to delete the multiple objects using a single request.

In this example, an object identifier (ID) may include the name of the bucket (e.g., a logical container) in which the object is stored (e.g., bucketA, bucketB, etc.), and an object key that identifies uniquely the object inside the bucket (e.g., “object123”). In some cases, if the object can have multiple versions of the data and metadata, the object ID may also include a version identifier.

The synchronization worker process 408 indicates an identifier of a synchronization worker process 126 executed by the storage program 122 by the service computing device 102 in the local storage system 112. The synchronization worker process 408 indicates the particular worker process that has been assigned to process synchronization of the corresponding data operation. For example, the service computing device 102 may perform a plurality of synchronization worker processes 126 asynchronously and in parallel.

The actor 410 indicates an identifier of an actor 410 able to send data operation requests to the local storage system 112 and indicates the actor who sent the data operation to the local storage system 112. For example, an actor 410 may be a particular client device 108, a particular internal background process in the local storage system 112, or the like.

The recent activity data structure 136 may be used to store the data operation requests that have been recently received by a respective service computing device 102. The data operation requests logged in the recent activity data structure 136 may expire over time and may be subsequently removed from the recent activity data structure 136. For example, only recent data operations may be included in the recent activity data structure 136 to avoid using a large amount of memory and/or storage for the recent activity data structure 136 and to avoid having to perform search operations within a large amount of data that might otherwise be retained in the recent activity data structure 136. The entries in the recent activity data structure 136 may be configured to expire and be deleted from the recent activity data structure 136, for example, based on a predefined or user-defined time threshold. Additionally, or alternatively, entries may be deleted from the recent activity data structure 136 via a delete request from the management computing device 110, or, as still other alternatives, when an allotted storage capacity for the recent activity data structure 136 falls below a predefined or user-defined threshold, or when the number of entries in the recent activity data structure 136 reaches a predefined or user-defined threshold.

The recent activity data structure 136 may have one or more entries, each entry corresponding to a respective row (e.g., rows 412-420 in the illustrated example) and may be maintained and updated by the storage program 122, such as by execution of the local storage process(es) 124. The recent activity data structure 136 may be maintained and updated similar to a FIFO queue in which newer entries for newly-receive data operation are added to the bottom of the recent activity data structure 136 and older entries to be deleted are removed from the upper rows of the data structure. As mentioned above, older entries may be deleted from the recent activity data structure 136 by request from the management program 148 on the management computing device 110, or by execution of the local storage process 124, such as when a threshold for controlling the size is reached, or the like, as described above.

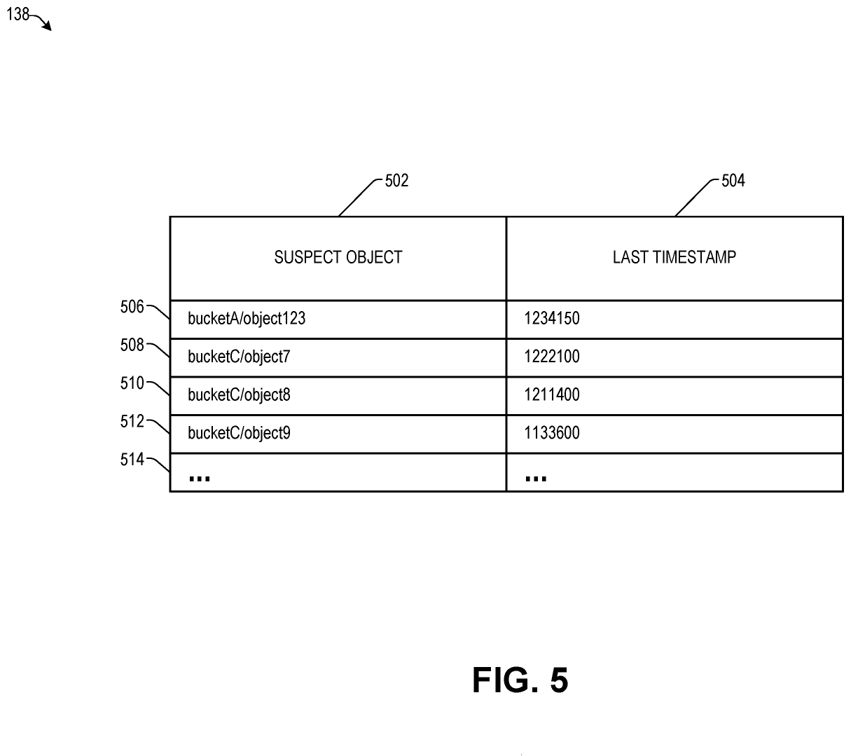

FIG. 5 illustrates an example of the suspect objects data structure 138 according to some implementations. The suspect objects data structure 138 lists those objects that have been determined to be more likely (e.g., based on the recent activity data structure or based on synchronization worker process failure) than other objects stored by the service computing device 102 to have been incorrectly synchronized to one or more of the external storage systems 114. The suspect objects data structure 138 includes suspect object 502 and last timestamp 504. Each row 506-514 of the suspect objects data structure 138 may receive an entry that includes information of a respective object that is suspected of not having been synchronized correctly to one or more of the external storage systems 114. Object 502 indicates an object identifier of a suspected object. Similar to the target objects 406 in the example of FIG. 4 discussed above, the suspect objects 502 may be identified by an object identifier that may include the name of the bucket (logical container) in which the object is stored, and an object key that identifies uniquely the respective object inside the bucket. Further, as mentioned above, the object identifier may also include a version identifier if the object is able to have multiple versions of its data and metadata.

The last timestamp 504 may include a timestamp at which the last data operation was applied to the corresponding suspect object 502. The suspect objects data structure 138 may be maintained and updated by the storage program 122, such as by execution of the local storage process(es) 124 and/or the reconciliation process(es) 128, using techniques as discussed additionally below.

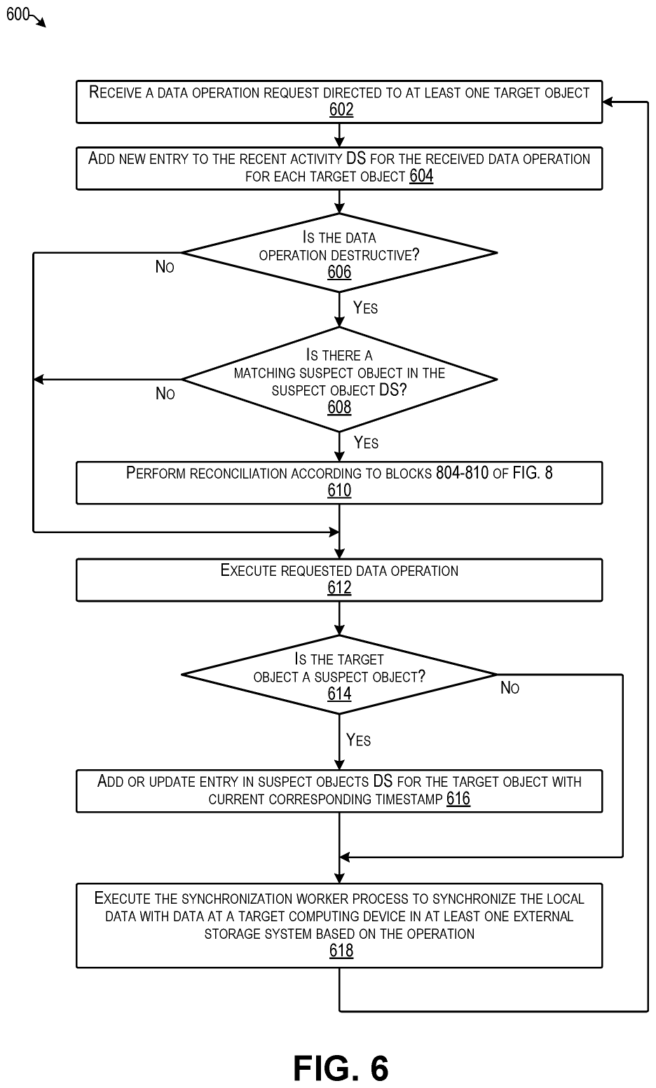

FIGS. 6-8 are flow diagrams illustrating example processes according to some implementations. The processes are illustrated as collections of blocks in logical flow diagrams, which represent a sequence of operations, some or all of which may be implemented in hardware, software or a combination thereof. In the context of software, the blocks may represent executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. For discussion purposes, the processes are described with reference to the environments, frameworks, and systems described in the examples herein, although the processes may be implemented in a wide variety of other environments, frameworks, and systems.

FIG. 6 is a flow diagram illustrating an example process 600 for handling incoming data operation requests according to some implementations. For example, a service computing device 102 may execute the storage program 122 to perform at least a portion of the process 600, which may correspond to operations performed by execution of one or more of the local storage processes 124 in some examples.

At 602, the service computing device 102 may receive a data operation request, such as from a client computing device 108, from a process executing on the service computing device 102, from a process executing on another computing device 102 or 104, or from the management program 148 executing on the management computing device 110. As one example, a local storage process 124 may be executed periodically by the service computing device 102 to reclaim storage space for object data set as deleted. As another example, a local storage process 124 may be executed by the service computing device 102, or another computing device, to enforce a lifecycle policy that determines when data has expired and is to be deleted. Data read operations are generally not considered in the data operations herein, as a read operation does not affect the state of the data stored in the local storage 130. Accordingly, the data operations herein may include write (PUT) operations, delete operations, update operations, changes to metadata, and so forth.

At 604, the service computing device 102 may generate a new entry in the recent activity data structure 136 for the received data operation request. The entry may include the information described above in the recent activity data structure 136, such as timestamp 402 at which the data operation request was received, type of the data operation 404, target object 406, and the actor 410 that originated the data operation request. The service computing device 102 may also assign a selected synchronization worker process 408 for synchronizing the received data operation to at least one external target computing device 104 at one or more of the external storage systems 114.

At 606, the service computing device 102 may determine whether the requested data operation is a destructive operation that is destructive of the targeted data. For instance, the service computing device 102 may determine whether the data operation will remove or otherwise change the state of the data in an irrecoverable way. One example of a destructive operation is a delete operation, such as a delete object operation that is performed in an environment in which space reclamation takes place immediately. Another example of a destructive operation is a space reclamation process that frees up the space of an object marked for deletion. Another example of a destructive operation is a PUT Object operation or other write operation performed on an object that already exists in an environment in which versioning is not enabled, which may result in overwriting the object data. If the operation is determined to be destructive, the process may go to 608. If the operation is not a destructive operation, then the process may go to 612.

At 608, the service computing device 102 may determine whether the target object is in the suspect objects data structure 138 by checking the suspect objects 502 for one or more matching object IDs. If a matching object ID is found, the process may go to 610. If a matching object ID is not found, the process may go to 612.

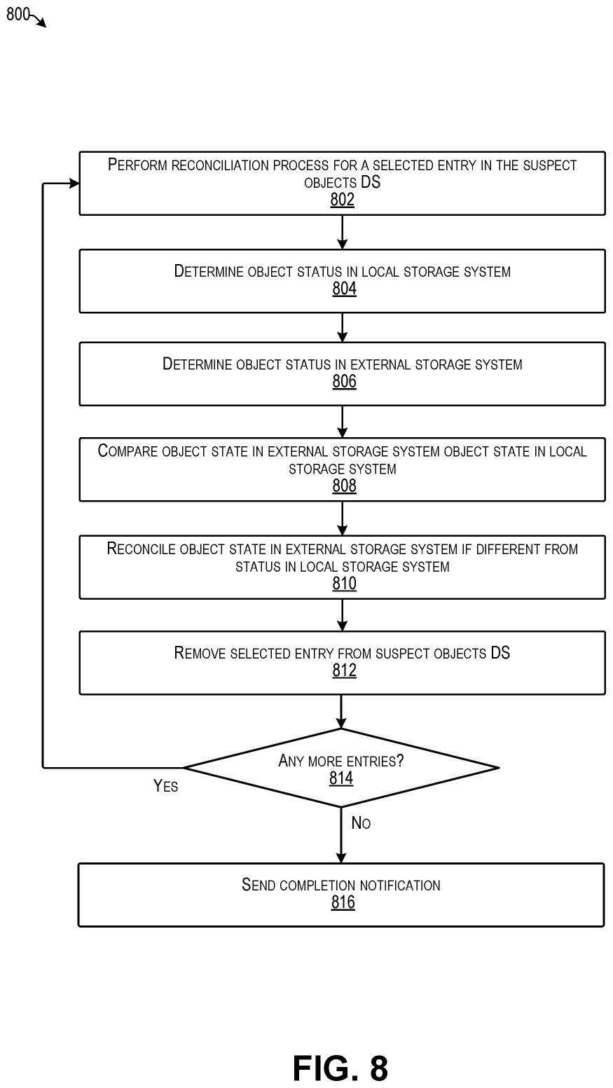

At 610, for each matching object identifier found in the suspect objects data structure 138, the service computing device 102 may consolidate the object status at the network storage system(s) 114 by executing a portion of the data reconciliation process 128, an example of which is set forth in FIG. 8 as process 800. As one example, the service computing device 102 may execute at least blocks 804-810 of the data reconciliation process 800 when the data synchronization rules indicate that delete operations are not synchronized to the network storage system(s) 114. For example, such a rule may prevent a situation in which data that may be required to consolidate, correct, or otherwise reconcile an incorrectly synchronized suspect object is no longer recoverable. Alternatively, in other examples of storage arrangements in which data destruction is not an issue, blocks 608 and 610 may be skipped.

At 612, the service computing device 102 may execute the requested data operation and wait until the execution has been completed.

At 614, following execution of the data operation, the service computing device 102 may determine whether the target object has become a suspect object by checking whether the target object is already in the suspect object data structure 136 or matches a target object already listed in the recent activity data structure 138 and, in the latter case, has a timestamp within a threshold time of the current time stamp. For example, the service computing device 102 may determine whether the target object matches an object 502 listed in any entry of the suspect object data structure 138. A target object that is already listed in the suspect object data structure 138 is considered suspect. In addition, if the target object is not listed in the suspect object data structure 138, the service computing device 102 may determine whether the target object matches any target objects 406 listed in any of the entries of the recent activity data structure 136 (except, of course, the entry just added for the data operation currently being processed). A target object that is already listed in the recent activity data structure 138 and was target of a recent operation may be considered suspect. As one example, a prior data operation may be considered recent if the difference between the current timestamp and the timestamp of the prior data operation is below a predefined or user-defined threshold time. For instance, the threshold time may be dependent at least in part on a latency in the system for synchronizing data to the external storage system(s) 114 and/or for detecting any synchronization worker process failures.

The synchronization processes 126 may include synchronization rules to filter which objects and/or operations are synchronized to the external storage system(s) 114 and which are not. For example, a synchronization rule may allow synchronization of write operations but not delete operations. If the incoming data operation being processed does not match the synchronization rules, the target object may not be considered suspect. Similarly, if a target object that is the target of the incoming data operation does not match the rules, the target object is not considered suspect.

As one example, according to the values provided in the example recent activity data structure 136 illustrated in FIG. 4, suppose that the predefined time threshold is 80, when the data operation corresponding to entry 414 is received following the entry 412. In this case, the target object “bucketA/object123” may be considered suspect because the difference in the respective timestamps 402 for the entry 414 and the entry 412 is 50, which is within the predefined threshold of 80. On the other hand, according to the values in the recent activity data structure 136 of FIG. 4, assuming that the predefined time threshold is 80, when the operation corresponding to entry 418 is received, the target object “bucketC/object789” is not considered to be suspect because even though two operations have been received for that object, the time difference of the timestamps of entry 416 and entry 418 is 100, which is above the threshold 80. Furthermore, when the operation corresponding to entry 420 is received, the target object “bucketD/objectD” is not considered suspect because there are no recent operations for that target object. Returning to the process 600 of FIG. 6, if the target object is determined to be suspect at 614, the process may go to 616. If not, the process may go to 618.

At 616, the service computing device 102 may update the suspect objects data structure 138 by adding or updating an entry for the suspect object with a current timestamp corresponding to receipt of the data operation request being processed. For example, for each target object considered suspect, if the target object already exists in the suspect objects data structure 138, the entry corresponding to the target object may be updated by setting the current timestamp as the last timestamp 504. For each target object considered suspect that does not already exist in the suspect objects data structure 138, a new entry may be created in the suspect objects data structure 138 with the target object ID as the suspect object 502, and the current timestamp for the received data operation as the last timestamp 504 for the new entry.

At 618, the service computing device 102 may synchronize the object data that was subject of the data operation with one or more target computing devices 104 at one or more of the external storage systems 114 based on the received data operation request being processed. For example, a data operation may result in creating a new object, adding, overwriting or removing all or a part of the data and metadata of an existing object, creating a new version of an existing object, or the like. In some examples, when the incoming data operation is a delete object operation, then the data synchronization worker process 126 may send a delete object operation to the one or more external storage systems 114. As another example, when the incoming data operation is a PUT object or other write operation, the synchronization worker process 126 may send a PUT object operation with the same data and metadata to the external storage system 114. As mentioned above, the synchronization worker process 126 may employ synchronization rules to filter which target objects and which data operations are synchronized and which are not. If the incoming data operation being processed or the corresponding target object does not match the rules for performing synchronization, then the synchronization worker process 126 does not perform synchronization for the data operation request. Following the execution of the synchronization worker process 126, the process 600 may return to 602 to await receipt of additional data operation requests.

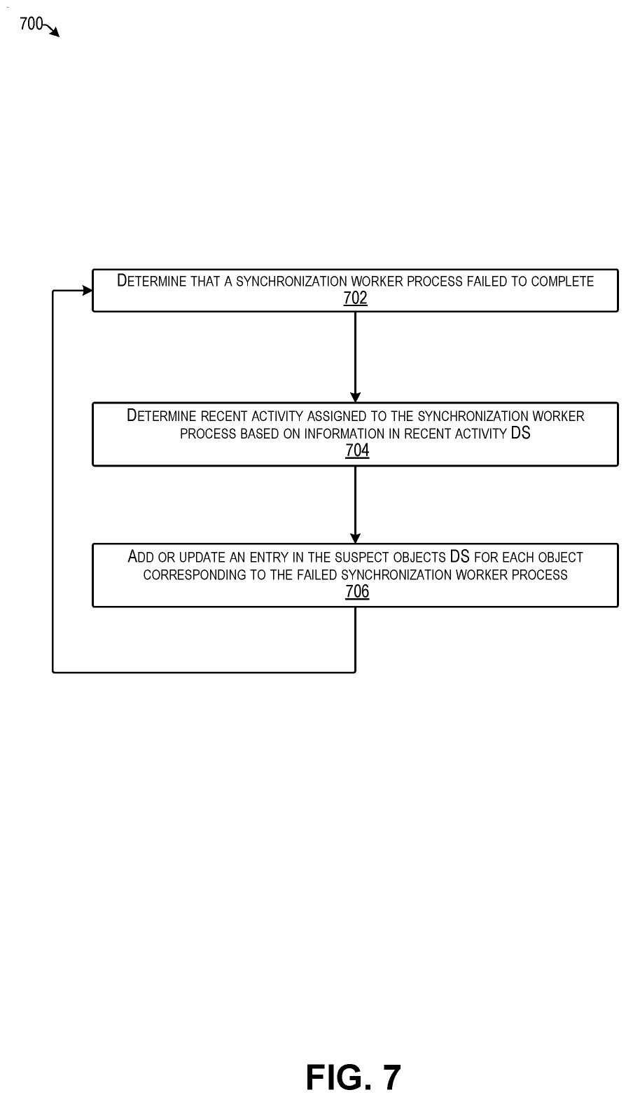

FIG. 7 is a flow diagram illustrating an example process 700 for recovering from a failure of a synchronization worker process according to some implementations. For example, a service computing device 102 or other suitable computing device, as discussed above, may execute the storage program 122 to perform at least a portion of the process 600, which may correspond to operations performed by execution of one or more of the local storage processes 124 in some examples.

At 702, the service computing device 102 may determine that a synchronization worker process failed to complete. For example, the process 700 may be initiated when a synchronization worker process 126 executing on a service computing device 102 at the local storage system 112 suffers a temporary or permanent failure. As one example, the service computing device 102 on which the synchronization worker process 126 is executing may suffer an unexpected power outage, equipment failure, communication failure, or the like. Failures in synchronization worker process(es) 126 may be monitored and detected by one or more of the service computing devices 102 that are not running the particular synchronization worker process 126 that fails. For example, one or more of the service computing devices 102 may execute a local storage process 124 that monitors synchronization worker process(es) 126 executing on other ones of the service computing devices 102. As another alternative, failure of the synchronization worker process 126 may be detected by a system administrator 150 who can trigger the process 700 via the management program 148 executing on the management computing device 110.

At 704, the service computing device 102 may retrieve, from the recent activity data structure 136 all the entries that are associated with the failed synchronization worker process 126, e.g., by checking for the corresponding worker ID in the synchronization worker processes 408. For instance, in the example illustrated in FIG. 4, supposed that the synchronization worker process 126 having ID “W1” has failed. The service computing device 102 performing the process 700 may identify the first entry 412 and the third entry 416 in the recent activity data structure 136 as corresponding to the failed synchronization worker process W1.

At 706, the service computing device 102 may iterate through each data operation in the entries identified at 704 (e.g., 412 and 416 in the example of FIG. 4), and for each corresponding target object 406, may determine if the identified object already exists in the suspect objects data structure 138. If the object does not exist, the service computing device 102 may add a new entry to the suspect objects data structure 138, in which the suspect object ID is entered as the suspect object 502, and one of the time of the failure or the current time is entered as the last timestamp 504. If the object already exists in the suspect objects data structure 138, the entry corresponding to the object is updated by setting one of the time of the failure or the current time as the last timestamp 504. The process may then return to 702 to process any other synchronization worker process(es) 126 that may have also suffered failures.

FIG. 8 is a flow diagram illustrating an example process 800 for reconciling suspect objects according to some implementations. For example, a service computing device 102 may execute the storage program 122 to perform at least a portion of the process 800, which may correspond to operations performed by execution of one or more of the local storage processes 124 and/or the reconciliation process(es) 128 in some examples.

At 802, the service computing device 102 may initiate the data reconciliation process 128. For example, the data reconciliation process 128 may be executed periodically within a relatively short time period, e.g., minutes or hours. Alternatively, or in addition, the data reconciliation process 128 may be executed after a predefined or user-defined time threshold has passed following the addition of a suspect object to the suspect objects data structure 138. For example, the service computing device 102 may check the last timestamp 504 in the suspect objects data structure 138 and may initiate the data reconciliation process 128 for a particular entry when an age of the timestamp exceeds a time threshold for execution of the data reconciliation process 128. Alternatively, or in addition, the data reconciliation process 128 may be executed when the number of suspect objects in the suspect objects data structure 138 reaches a predefined or user-defined threshold. Alternatively, or in addition, the data reconciliation process 128 may be executed when a failure in a synchronization worker process 126 is detected, e.g., after the process 700 of FIG. 7 has been executed. Alternatively, or in addition, the data reconciliation process 128 may be initiated by the administrator 150 and/or the management program 148, such as by an administrator instruction sent from the management computing device 110. Following initiation of the data reconciliation process 128, the service computing device 102 may iterate through each suspect object 502 in the suspect objects data structure 138. For example, execution of the data reconciliation process may cause the service computing device 102 to iterate through each entry in the suspect objects data structure 138.

At 804, the service computing device 102 may check the current state of the object in the local storage system 112. As one example, the service computing device 102 may check the current state of the object by determining whether the object exists, and if the object exists, the status of the object, the size of the object, and so forth. In addition, the service computing device 102 may access the object metadata for the object, which may include a pre-calculated hash of the object data, or alternatively, the data reconciliation process 128 may calculate a hash of the object. Furthermore, if object versioning is enabled, the status of the previous object versions may also be accessed.

At 806, the service computing device 102 may determine the current state of the object in the one or more external storage systems 114. For example, the service computing device 102 may check whether the object exists in the external storage system 114, and if so, may retrieve the same or similar features to those discussed above.

At 808, the service computing device 102 may compare the state of the object retrieved from the local storage system 112 with the state of the object retrieved from the external storage system. For example, the service computing device 102 may compare the retrieved features for the object in the local storage and the object at the external storage system 114 to determine whether they have the same state (e.g., same size, same version, matching hashes, similar metadata). For instance, if the object does not exist in both storage systems 112, 114, the object is considered to be correctly synced. If the object exists in both storage systems 112, 114, and has the same metadata and hash for the data, the object is considered to be correctly synced. Otherwise, if the states are not substantially the same, the object is considered to not be correctly synced to the external storage system 114.

At 810, when the object is determined to not be correctly synchronized, the service computing device 102 may reconcile the object by causing at least one data operation to be performed at the target computing device to change the state of the synchronized object. Examples of data operations that may be performed for reconciling the synchronized object with the object stored by the service computing device 102 may include writing, updating or deleting data in the target computing device 104 of the external storage system, so that the synchronized object is correctly synchronized and the state of the synchronized object at the external storage system corresponds to or otherwise matches the state of the object at the local storage system, e.g., according to the synchronization rules. This operation may be coordinated with block 614 of the process 600 of FIG. 6 to avoid processing the same object at the same time. In addition, this operation may also consider the synchronization rules that specify which operations are synchronized and/or which objects are synchronized. For example, if a PUT object tag is configured to not be synchronized, then the comparing operation does not compare the tags in the metadata of the object to determine whether the metadata tags of the object are correctly synchronized, and thus, when making the states of the object and the synchronized object match, the metadata tags are not considered and do not have to match. Additionally, when object versioning is enabled at both the local storage system 112 and the external storage system 114, this operation may also check the state of all versions of the objects.

At 812, when reconciliation of the object is completed, the service computing device 102 may remove the selected entry of the object from the suspect objects data structure 138.

At 814, the service computing device 102 may determine whether there are any more entries remaining in the suspect objects data structure 138. If so, the process returns to 802 to select a next entry for processing. If not, then no entries remain in the suspect objects data structure 138, and the process goes to 816.

At 816, the process may send a completion notification to the storage program and/or other process that initiated the reconciliation process 128.

The example processes described herein are only examples of processes provided for discussion purposes. Numerous other variations will be apparent to those of skill in the art in light of the disclosure herein. Further, while the disclosure herein sets forth several examples of suitable frameworks, architectures and environments for executing the processes, the implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art. Additionally, while several example systems have been described, numerous other systems able to implement the storage and capacity-usage-balancing techniques herein will be apparent to those of skill in the art having the benefit of the disclosure herein.

Various instructions, processes, and techniques described herein may be considered in the general context of computer-executable instructions, such as programs stored on computer-readable media, and executed by the processor(s) herein. Generally, programs include routines, modules, applications, objects, components, data structures, executable code, etc., for performing particular tasks or implementing particular abstract data types. These programs, and the like, may be executed as native code or may be downloaded and executed, such as in a virtual machine or other just-in-time compilation execution environment. Typically, the functionality of the programs may be combined or distributed as desired in various implementations. An implementation of these programs may be stored on computer storage media or transmitted across some form of communication media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed:

1. A system comprising:
a first computing device associated with a first storage system able to communicate over a network with at least one second computing device associated with at least one second storage system that is remotely located with respect to the first storage system, the first computing device including one or more processors configured by executable instructions to perform operations comprising:
generating, by the one or more processors, a first data structure that includes a listing of one or more objects, the one or more objects listed in the first data structure having been determined to be more likely than other objects stored by the first computing device to have been incorrectly synchronized to a second computing device;
based at least in part on a first object being listed in the first data structure, comparing, by the one or more processors, a state of the first object stored by the first computing device with a state of a synchronized object stored by the second computing device;
based at least on determining a difference between the state of the first object and the state of the synchronized object, reconciling, by the one or more processors, the difference between the state of the first object and the state of the synchronized object by causing at least one data operation to be performed at the second computing device to change the state of the synchronized object; and
removing, by the one or more processors, the listing of the first object from the first data structure.

2. The system as recited in claim 1, the operations further comprising:
receiving a data operation request for a target object; and
based at least in part on determining that the data operation request was received within a threshold time of a prior data operation request for the target object, adding an entry to the first data structure to list the target object in the first data structure.

3. The system as recited in claim 2, the operations further comprising:
adding information related to the data operation request to a second data structure, the information including a time associated with receipt of the data operation request; and
determining that the data operation request was received within the threshold time of the prior data operation request for the target object based on comparing the time associated with receipt of the data operation request and a time associated with receipt of the prior operation request included in the second data structure.

4. The system as recited in claim 1, the operations further comprising:
receiving a data operation request for a target object;
checking the first data structure to determine whether the target object is already listed in the first data structure; and
based on the target object already being listed in the first data structure, updating a time associated with the target object in the first data structure based on a time associated with the received data operation request.

5. The system as recited in claim 1, the operations further comprising:
determining that a synchronization process for synchronizing a target object to the second computing device has failed; and
based on the failure of the synchronization process, adding an entry to the first data structure to list the target object in the first data structure.

6. The system as recited in claim 1, the operations further comprising:
receiving, by the first computing device, a data operation request for a target object;
determining whether the data operation request is destructive of data of the target object already stored by the first computing device;
based on determining that the data operation request is destructive, checking the first data structure to determine whether the target object is listed in the first data structure; and
based on the target object being listed in the first data structure, comparing a state of the target object stored by the first computing device with a state of a synchronized target object stored by the second computing device prior to executing the data operation request.

7. A method comprising:
generating, by a first computing device, a first data structure that includes a listing of one or more objects, the one or more objects listed in the first data structure having been determined to be more likely than other objects stored by the first computing device to have been incorrectly synchronized to a second computing device;
based at least in part on a first object being listed in the first data structure, comparing a state of the first object stored by the first computing device with a state of a synchronized object stored by the second computing device; and
based at least on determining a difference between the state of the first object and the state of the synchronized object, reconciling the difference between the state of the first object and the state of the synchronized object by causing at least one data operation to be performed at the second computing device to change the state of the synchronized object.

8. The method as recited in claim 7, further comprising:
receiving, by the first computing device, a data operation request for a target object; and
based at least in part on determining that the data operation request was received within a threshold time of a prior data operation request for the target object, adding an entry to the first data structure to list the target object in the first data structure.

9. The method as recited in claim 8, further comprising:
adding information related to the data operation request to a second data structure, the information including a time associated with receipt of the data operation request; and
determining that the data operation request was received within the threshold time of the prior data operation request for the target object based on comparing the time associated with receipt of the data operation request and a time associated with receipt of the prior operation request included in the second data structure.

10. The method as recited in claim 7, further comprising:
receiving, by the first computing device, a data operation request for a target object;
checking the first data structure to determine whether the target object is already listed in the first data structure; and
based on the target object already being listed in the first data structure, updating a time associated with the target object in the first data structure based on a time associated with the received data operation request.

11. The method as recited in claim 7, further comprising:
determining that a synchronization process for synchronizing a target object to the second computing device has failed; and
based on the failure of the synchronization process, adding an entry to the first data structure to list the target object in the first data structure.

12. The method as recited in claim 7, further comprising:
receiving, by the first computing device, a data operation request for a target object;
determining whether the data operation request is destructive of data of the target object already stored by the first computing device;
based on determining that the data operation request is destructive, checking the first data structure to determine whether the target object is listed in the first data structure; and
based on the target object being listed in the first data structure, comparing a state of the target object stored by the first computing device with a state of a synchronized target object stored by the second computing device prior to executing the data operation request.

13. The method as recited in claim 7, wherein the first computing device is configured to perform the comparing and the reconciling at least one of:
based on a time threshold being exceeded;
based on a difference between a timestamp associated with an entry in the first data structure and a current time;
based on a number of entries in the first data structure exceeding an entry number threshold;
based on detecting a failure of a synchronization process; or
based an instruction received from a management computing device.

14. The method as recited in claim 7, wherein the first computing device is included in a first storage system at a first site and the second computing device is included in a second storage system at a second site that is remote from the first site and the first storage system.

15. One or more non-transitory computer-readable media storing instructions that, when executed by one or more processors of a first computing device, configure the one or more processors to perform operations comprising:
generating, by the one or more processors, a first data structure that includes a listing of one or more objects, the one or more objects listed in the first data structure having been determined to be more likely than other objects stored by the first computing device to have been incorrectly synchronized to a second computing device;
based at least in part on a first object being listed in the first data structure, comparing, by the one or more processors, a state of the first object stored by the first computing device with a state of a synchronized object stored by the second computing device; and
based at least on determining a difference between the state of the first object and the state of the synchronized object, reconciling, by the one or more processors, the difference between the state of the first object and the state of the synchronized object by causing at least one data operation to be performed at the second computing device to change the state of the synchronized object.

16. The one or more non-transitory computer-readable media as recited in claim 15, the operations further comprising:
receiving a data operation request for a target object; and
based at least in part on determining that the data operation request was received within a threshold time of a prior data operation request for the target object, adding an entry to the first data structure to list the target object in the first data structure.

17. The one or more non-transitory computer-readable media as recited in claim 16, the operations further comprising:
adding information related to the data operation request to a second data structure, the information including a time associated with receipt of the data operation request; and
determining that the data operation request was received within the threshold time of the prior data operation request for the target object based on comparing the time associated with receipt of the data operation request and a time associated with receipt of the prior operation request included in the second data structure.

18. The one or more non-transitory computer-readable media as recited in claim 15, the operations further comprising:
receiving a data operation request for a target object;
checking the first data structure to determine whether the target object is already listed in the first data structure; and
based on the target object already being listed in the first data structure, updating a time associated with the target object in the first data structure based on a time associated with the received data operation request.

19. The one or more non-transitory computer-readable media as recited in claim 15, the operations further comprising:
determining that a synchronization process for synchronizing a target object to the second computing device has failed; and
based on the failure of the synchronization process, adding an entry to the first data structure to list the target object in the first data structure.

20. The one or more non-transitory computer-readable media as recited in claim 15, the operations further comprising:
receiving, by the first computing device, a data operation request for a target object;
determining whether the data operation request is destructive of data of the target object already stored by the first computing device;
based on determining that the data operation request is destructive, checking the first data structure to determine whether the target object is listed in the first data structure; and
based on the target object being listed in the first data structure, comparing a state of the target object stored by the first computing device with a state of a synchronized target object stored by the second computing device prior to executing the data operation request.
